(19) United States
(12) Patent Application Publication
(10) Pub. No.: US 2016/0312956 A1
(43) Pub. Date: Oct. 27, 2016

(54) METAL HYDRIDE HYDROGEN STORAGE TANK FOR CONTAINING HYDRIDES

(71) Applicants: COMMISSARIAT À L 'ÉNERGIE ATOMIQUE ET AUX ENERGIES ALTERNATIVES, Paris (FR); MCPHY ENERGY, La Motte Fanjas (FR)

(72) Inventors: Albin CHAISE, Grenoble (FR); David BOUFFETIER, Grenoble (FR); Cedric DUPUIS, Saint Romans (FR); Mariana DUPUIS-ROSCA, Saint Romans (FR); Manon ELIE, Grenoble (FR); Olivier GILLIA, Sassenage (FR); David VEMPAIRE, Claix (FR)

(73) Assignees: COMMISSARIAT À L 'ÉNERGIE ATOMIQUE ET AUX ENERGIES ALTERNATIVES, Paris (FR); MCPHY ENERGY, La Motte Fanjas (FR)

(21) Appl. No.: 15/106,063

(22) PCT Filed: Dec. 16, 2014
(86) PCT No.: PCT/EP14/78071

§ 371 Date: Jun. 17, 2016

(30) Foreign Application Priority Data
Dec. 17, 2013 (FR) 13 62783

(51) Int. Cl. F17C 11/00; F17C 1/16; F28D 7/10; F17C 1/12

(52) U.S. Cl. CPC F17C 11/005; F17C 1/12; F17C 1/16; F28D 7/103; F17C 2201/0166; F17C 2203/0362; F17C 2203/066; F17C 2205/0149; F17C 2221/012; F17C 2270/0168; F17C 2209/2109; F17C 2209/22; F17C 2209/234; F17C 2203/037

(57) ABSTRACT

A tank for storing hydrogen by absorption in a hydrogen storage material, including: a chamber; a hydrogen supplier to supply hydrogen into the chamber and/or collect hydrogen in the chamber; an inner structure for storing hydrogen storage material, the inner structure including at least two cups, each cup including a base, a side wall, and a closing element forming a volume impermeable to the hydrogen storage material, at least part of each cup being permeable to hydrogen, and the inner structure including a passage provided at least between part of an outer face of the side wall of the cup and an inner face of the chamber.

### TECHNICAL FIELD AND PRIOR ART

The present invention relates to a metal hydride hydrogen storage tank providing efficient confinement of hydrides.

Alternative energies to petroleum are being sought due, notably, to the reduction in petroleum reserves. One of the promising vectors for these energy sources is hydrogen, which may be used in fuel cells to produce electricity.

Hydrogen is a very widespread element in the universe and on Earth, it may be produced from natural gas or other hydrocarbons, but also by simple electrolysis of water using for example electricity produced by solar or wind energy.

Hydrogen fuel cells are already used in certain applications, for example in automobile vehicles but are still not very widespread, notably on account of the precautions that need to be taken and the difficulties for the storage of hydrogen.

Hydrogen may be stored in compressed form between 350 and 700 bars, which poses safety problems. It is then necessary to provide tanks capable of withstanding these pressures, knowing moreover that these tanks, when they are mounted in vehicles, may be subjected to shocks.

It may be stored in liquid form, however this storage only ensures low storage efficiency and does not enable storage over long durations. The passage of a volume of hydrogen from the liquid state to the gaseous state in normal conditions of pressure and temperature produces an increase in its volume by a factor of around 800. Hydrogen tanks in liquid form are not in general very resistant to mechanical shocks, which poses important problems of safety.

The so-called “solid” storage of hydrogen in the form of hydride also exists. This storage allows a considerable storage volume density and implements a moderate pressure of hydrogen while minimising the energy impact of the storage on the overall efficiency of the hydrogen chain, i.e. from its production to its conversion into another energy.

The principle of solid storage of hydrogen in hydride form is the following: certain materials and in particular certain metals have the capacity of absorbing hydrogen to form a hydride, this reaction is called absorption. The hydride formed may again give gaseous hydrogen and a metal. This reaction is called desorption. Absorption or desorption occur as a function of the partial pressure of hydrogen and the temperature.

The absorption and the desorption of hydrogen on a powder or a metal matrix M take place according to the following reaction:

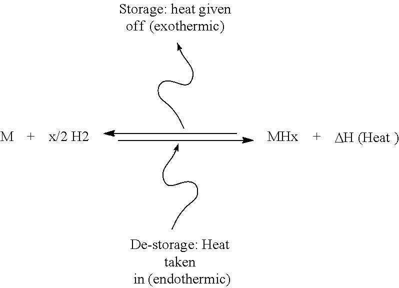

M being the powder or metal matrix,
MHx being the metal hydride.

A metal powder is for example used, which is placed in contact with hydrogen, a phenomenon of absorption appears and a metal hydride forms. The release of hydrogen takes place according to a desorption mechanism.

The storage of hydrogen is an exothermic reaction, i.e. which gives off heat, whereas the release of hydrogen is an endothermic reaction, i.e. which absorbs heat.

In a practically systematic manner, the hydride and the metal, which are both in the form of powder in the tanks, have a difference in density between 10% and 30%.

This variation in density within the tank has two consequences:
on the one hand, the appearance of stresses inside the grains of powder during absorption-desorption cycles, which causes their fractionation into smaller grains. This phenomenon is called decrepitation,
on the other hand, the swelling of the grains of powder during the absorption of hydrogen and the deswelling of the grains during desorption. A free volume above the powder is then provided to take account of this swelling.

The phenomenon of decrepitation and the phenomenon of swelling are responsible for progressive densification of the bed of powder as the number of absorption-desorption cycles increases. In fact, decrepitation makes finer and finer powders appear which migrate by gravity to the base of the tank through the network of grains. In addition, when the speed of the flow of hydrogen is sufficiently high, the grains are moved and rearranged in the tank. Furthermore, the bed of powder tends to retract, i.e. see its volume reduce during desorption which leaves an empty space between the walls of the tank and the bed of hydrogen storage material. A migration of powders takes place by gravity via this space and fills it in. During the following absorption, the hydride powder formed is not going to behave like a fluid. In particular, the level of the bed of powder in the tank is not that attained during the preceding absorption. In fact the rubbing of the grains against each other and against the wall of the tank prevent the bed of powder from expanding freely. The swelling of the grains of powder is then compensated by the reduction in the size of the porosities.

The bed of hydrogen storage material/hydride thus progressively becomes denser during hydridation cycles.

“Hydridation cycle” designates a phase of absorption followed by a phase of desorption of hydrogen.

It is thus important to avoid an accumulation of hydrogen storage material in a deep confined space which could apply stresses that could deteriorate the structure of the tank.

In order to reduce the problems linked to the accumulation and to the swelling of the storage material, it has been proposed to compartmentalise the quantity of storage material implemented. For this purpose, tanks in which the storage material is distributed in different stages have been proposed. The tank comprises a ferrule traversed longitudinally by a porous tube for the distribution and the collection of hydrogen and cupels mounted around the porous tube and delimiting the stages. If the cups do not delimit impermeable housings, the material in powder form during decrepitation can pass between the ferrule and the cup and/or between the cupel and the porous tube. The material accumulates in the lower stages and in the base of the tank.

For example, the document US20040178083 describes an example of hydrogen tank comprising a plurality of superimposed compartments each comprising a base and a side wall. The compartments are stacked along the axis of the tank and tubes made of porous material extend along the axis of the tank and traverse the compartments to distribute hydrogen within the hydride contained in the compartments in charge phase, and to collect hydrogen released by this hydride in discharge phase. The compartments are made of a thermal conductive material and in contact with the recipient of the tank. Thus thermal exchanges take place through the wall of the recipient for controlling the charging and discharging of hydrogen.

The structure of this tank does not make it possible to ensure sealed confinement of the hydride in the compartments. In fact, the presence of openings in the base of the compartments to enable the passage of tubes for distributing and collecting hydrogen and the presence of a necessary play between the tubes and these openings causes leakages of powder which is going to accumulate in the base of the tank. Moreover, such a tank imposes great precision in the formation of the recipient and the compartments in order to ensure contact between the inner face of the recipient and the outer face of the side walls of the compartments, said contact being necessary for thermal exchanges.

The document U.S. Pat. No. 4,489,564 describes a tank of hydrogen in hydride form comprising a chamber in which is arranged a sleeve made of flexible woven metal, the hydride is stored in the sleeve which deforms radially, as a function of the expansion of the hydride. This sleeve has meshes which allow the hydride to pass in the form of powder. A risk of accumulation exists.

### DESCRIPTION OF THE INVENTION

It is consequently an aim of the present invention to offer a hydrogen storage device providing efficient confinement of the hydrogen storage material and of simplified formation.

The aforementioned aim is attained by a tank of storage material comprising a chamber, and an inner structure delimiting a plurality of housings impermeable to the powder and permeable to hydrogen, a play being provided between at least part of the side surface of the inner structure and the inner face of the ferrule, said play being used to supply the storage material with hydrogen to store and/or to collect released hydrogen.

Thanks to the invention, it is possible to avoid the presence of one or more tubes traversing the compartments to bring hydrogen within the compartments and its collection, powder leakage areas are thus done away with. Moreover, the inner structure for storing the storage material not being in contact with the ferrule, the formation of the tank is simplified, the manufacturing precision of the ferrule and the inner structure being substantially reduced.

In other words, the hydrogen tank according to the invention comprises closed cups so as to be impermeable to the storage material in powder form, and permeable to hydrogen, which avoids any leakage of powder and thus its accumulation in areas capable of mechanically weakening the tank.

Permeability to hydrogen is for example obtained by the formation of one or more openings in the inner structure sealed off by a material permeable to hydrogen, for example a grating, a fabric, of which the size of the meshes prevents the passage of the powder. The housings could alternatively be made entirely from a material porous to hydrogen, for example made of sintered material.

In an advantageous formation, the housings are made of plastic material.

In an embodiment, the housings are formed by individual cups comprising a base, a side wall and a cover delimiting an inner space impermeable to the powder. The cups are impermeable to the powder individually and are stacked in the ferrule. In an embodiment, the housings are formed by cups, the base of an upper cup forming the cover of a lower cup. The base of the upper cup cooperates with the free edge of the lower cup, for example by screwing, nesting, etc., so as to delimit a space impermeable to the powder in the lower cup.

The tank according to the invention is particularly suited to the slow storage of hydrogen, for example the seasonal storage of hydrogen or over long periods, which does not require fast storing and de-storing speeds and hence does not require important thermal exchanges

The subject matter of the present invention is then a tank for storing hydrogen by absorption in a hydrogen storage material, comprising a chamber, means capable of supplying hydrogen into the chamber and collecting hydrogen in the chamber, an inner structure for storing hydrogen storage material, said inner structure comprising at least two cups, each cup comprising a base, a side wall and a closing element forming a volume impermeable to the powdered storage material, at least part of each cup being permeable to hydrogen, and the inner structure being such that a passage is provided at least between part of an outer face of the side wall of the cups and an inner face of the chamber.

The means capable of supplying hydrogen into the chamber (2) and collecting hydrogen in the chamber are connected to the passage provided at least between part of the outer face of the side wall of the cups and the inner face of the chamber.

Advantageously, said at least one part permeable to hydrogen is formed at least in the side wall of the cups. The side wall may then comprise at least one opening sealed off by an element impermeable to the powdered storage material and permeable to hydrogen. The element impermeable to the powdered storage material and permeable to hydrogen is for example a grating or a porous material or a fabric.

Alternatively, at least one of the side walls is made entirely of a material impermeable to the storage material and permeable to hydrogen, for example at least the side wall is made of sintered material.

Preferably, the cups are self-supporting.

In an embodiment, the closing element of each cup is a cover, separate from the other cups.

In another embodiment, the inner structure comprises several stacked cups, the closing element of a lower cup being formed by the base of an upper cup. For example, the cups cooperate by nesting. Preferably, locking means between the cups are provided so as to make the cups integral with each other in a durable manner.

The locking means are for example of bayonet type. For example, the side wall of the lower cup comprises at least one slug or at least one notch and the base of the upper cup comprises at least one notch or at least one slug respectively, the at least one slug cooperating with the at least one notch by an axial coming together movement and a rotational movement in order to lock the lower cup and the upper cup.

According to another example, the locking means are screwing means or instead clipping means.

The tank may comprise sealing means interposed between the side wall and the closing element of the cup, these sealing means being impermeable to the powdered storage material.

In an advantageous example, the cups are made of plastic material, for example moulded polypropylene. Advantageously, in this case the element impermeable to the hydrogen storage material and permeable to hydrogen is secured to the side surface of the cups during the moulding thereof.

The tank may comprise a jacket surrounding at least in part the chamber and means of circulating a heat transfer fluid in the jacket.

The subject matter of the present invention is also a method of manufacture of a storage material storage tank according to the invention, comprising,

a) the formation of the chamber,

b) the formation of the cups,

c) the filling of the cups with the storage material,

d) the sealed closing of the cups,

e) the putting in place in the chamber,

f) the closing of the chamber.

Step d) may be carried out by means of covers separate from the other cups or by stacking of the cups, the lower cup being closed by the upper cup.

Step d) may comprise a step of locking the cups together.

Step b) may be a formation by moulding of plastic material. During moulding, preferably the element permeable to hydrogen is made integral with the remainder of the cup.

Alternatively during step b), the cups are formed by sintering so as to be impermeable to the powdered storage material and permeable to hydrogen.

### BRIEF DESCRIPTION OF THE DRAWINGS

The present invention will be better understood from the description that follows and the appended drawings in which:

FIG. 1 is a longitudinal sectional view of an example of tank according to the invention represented schematically,

FIG. 2 is a longitudinal sectional view of another example of tank according to the invention represented schematically,

FIG. 3 is a schematic longitudinal sectional view of a first embodiment of a stack of impermeable cups cooperating with each other implemented by the present invention,

FIG. 4A is a detail view of an example of cooperation between the cups according to the embodiment of FIG. 3,

FIG. 4B is a detail view of example of cooperation between the cups according to the embodiment of FIG. 3,

FIG. 5 is a detail view of another example of formation of cooperation between cups,

FIGS. 6A and 6B are detail views of FIG. 5,

FIGS. 7A and 7B are detail views of two variants of another example of cooperation between cups,

FIGS. 8A and 8B are longitudinal sectional views of two variants of another example of the first embodiment of a stack of impermeable cups cooperating with each other implemented by the present invention,

FIG. 9 is a longitudinal sectional view of a second embodiment of an independent impermeable cup implemented by the present invention,

FIG. 10 is a side view of an example of cup provided with an opening permeable to hydrogen,

FIG. 11 is a side view of another example of cup provided with an opening permeable to hydrogen.

### DETAILED DESCRIPTION OF PARTICULAR EMBODIMENTS

In the remainder of the description, metal hydrides will be designated by “storage material”.

“Hydridation cycle” designates a phase of absorption followed by a phase of desorption of hydrogen.

In the description that follows, the tank(s) described have a cylindrical revolution shape, which represents the preferred embodiment. Nevertheless any tank formed by a hollow element having a longitudinal dimension greater than its transversal dimension, and having any section, for example polygonal or ellipsoidal, does not go beyond the scope of the present invention.

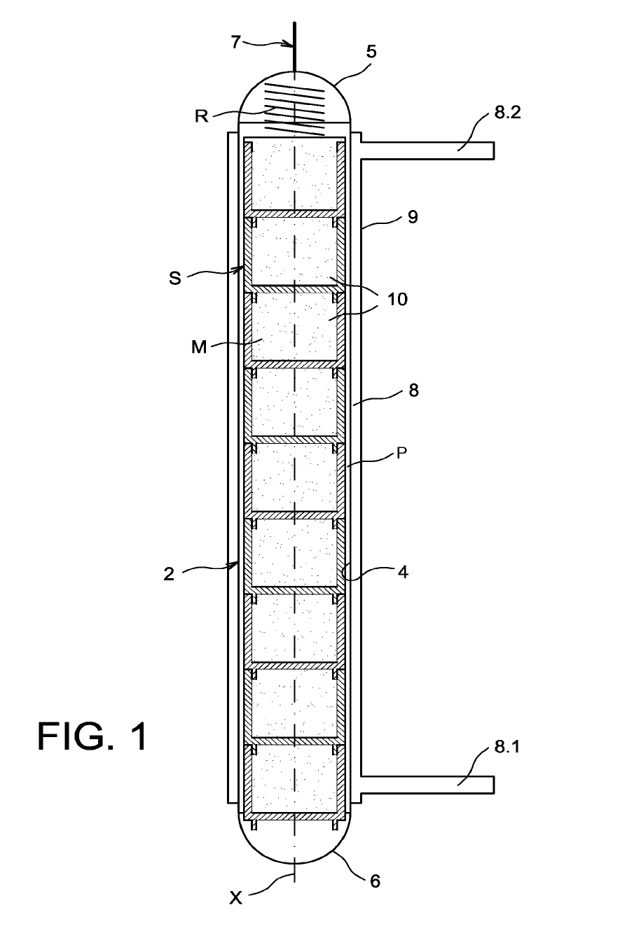

In FIG. 1 may be seen an example of formation of a hydrogen tank according to the invention comprising a chamber 2 in which is stored the storage material. The chamber is formed of a ferrule 4 of longitudinal axis X closed at a lower end by a lower base 6 and closed at an upper end by an upper base 5. The ferrule 4 is, in the example represented, of circular section.

The tank is intended to be generally oriented so that the longitudinal axis X is substantially aligned with the direction of the gravity vector. However, during its use, notably in the case of on-board use, its orientation may change.

The chamber is intended to withstand a certain hydrogen pressure, typically between 0.1 bar and 1000 bars. The tank includes means 7 for supplying hydrogen and collecting hydrogen. In the example represented, it is a tapping formed through the upper base 5 of the chamber. The supply and collection means may be separate.

The tank also comprises a jacket 8 largely surrounding the chamber, the jacket delimits around the chamber a sealed volume in which is intended to circulate a heat transfer fluid 9 in order to bring heat to the storage material or to extract heat from said storage material. In the example represented, the jacket 8 comprises a connection for supplying 8.1 with heat transfer fluid situated preferably in the lower part of the jacket and a connection for evacuating heat transfer fluid situated preferably in the upper part 8.2 of the jacket 8 so as to use the phenomenon of natural convection in thermal exchanges. Thus the fluid circulates from the base upwards around the chamber and exchanges heat with the chamber by forced convection and by natural convection. For example, the heat transfer fluid is air, water, an oil or a gas.

The tank also comprises an inner structure S for storing the storage material M arranged in the chamber 2. The inner structure S is received with play in the chamber such that a passage P exists between the outer face of the structure S and the inner face of the chamber 2, said passage serving for the supply and for the collection of hydrogen as will be described hereafter.

For example the storage material is a hydride chosen from the family of alanates, AB₅, AB₂, AB, BCC or simple elements (e.g.: LaNi₅, TiFe, TiVCr, Mg, etc.).

The dimensions of the particles depend on the storage material used. The particles have dimensions varying preferably between 0.1 μm and 1 mm or even ten or so millimetres, preferably between 1 μm and 100 μm. It should be noted that a mixture of powder comprises particles of different sizes. A very large majority of the weight percentage of the mixture of powder is composed of particles of a given minimum size and particles of smaller size form the remaining weight percentage.

The inner structure S comprises a plurality of cups 10 stacked on each other. The storage material is confined in a sealed manner in each of the cups. The cups are rigid and each forms a self-supporting element capable of supporting one or more cups containing the storage material so as to enable the formation of a stack. The jacket, at least the heat transfer fluid, surrounds a large part of the area of the chamber containing the storage material, for example 90% of the area of the chamber containing the storage material.

In the present application, an element impermeable to storage material is taken to mean an element that allows less than 10% by weight of storage material to pass, these 10% being composed of particles of the smallest sizes composing the storage material. The different embodiments of this sealing are described in the reminder of the description.

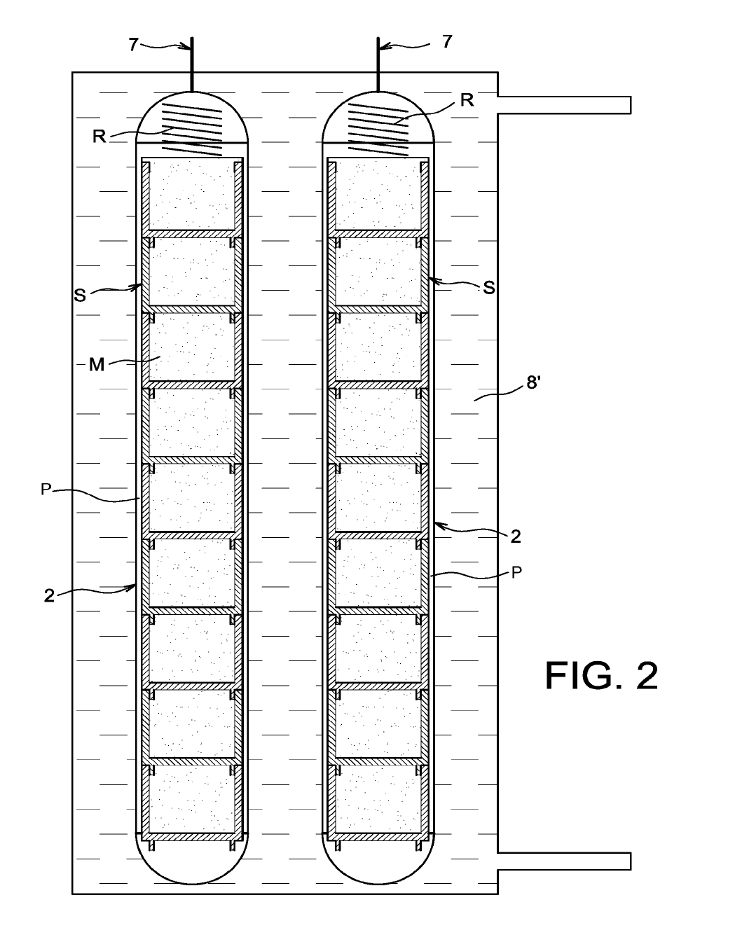

In FIG. 2 may be seen another example of formation of a tank comprising two chambers 2 arranged in a single jacket 8′. It will be understood that the tank may comprise more than two chambers in a same jacket or then several jackets each containing one or more chambers.

Alternatively, the tank could uniquely comprise one or more chambers exchanging calories by natural convection directly with the ambient air.

The implementation or not of a jacket depends on the speed at which it is wished to absorb or desorb hydrogen.

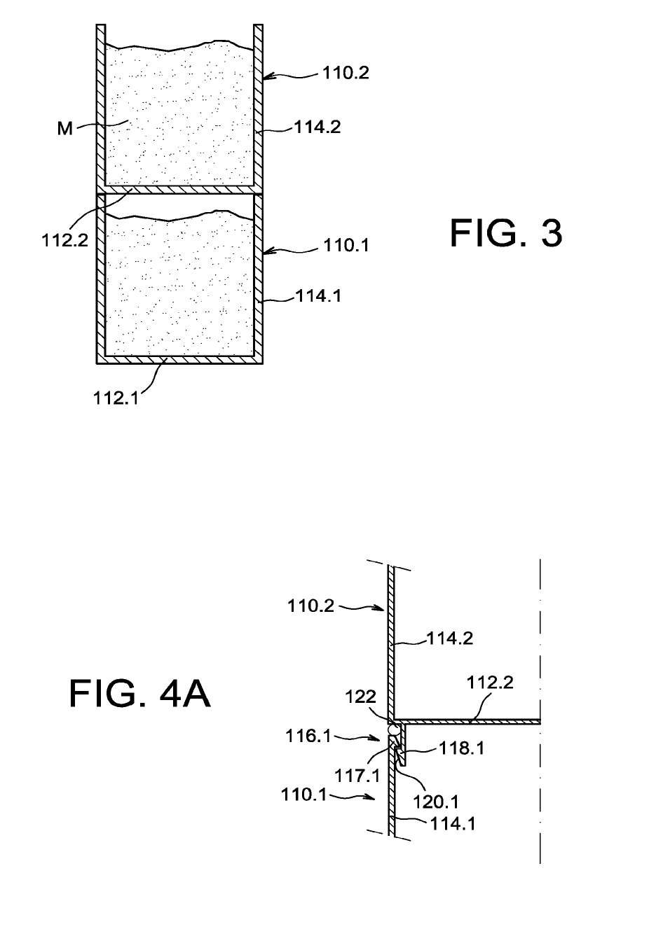

In FIG. 3 may be seen a first embodiment of an inner structure according to the invention represented schematically comprising a plurality of cups forming a stack. In this embodiment, the cups 110.1, 110.2 are stacked and the upper cup 110.2 seals off in a sealed manner the lower cup 110.1. Each cup 110.1, 110.2 comprises a base 112.1, 112.2, and a side wall 114.1, 114.2 respectively. The base of the upper cup 112.2 is such that it ensures a closing of the lower cup 110.1 impermeable to the powder. The base of the upper cup 110.2 and the free end 116.1 of the lower cup cooperate to achieve this sealing.

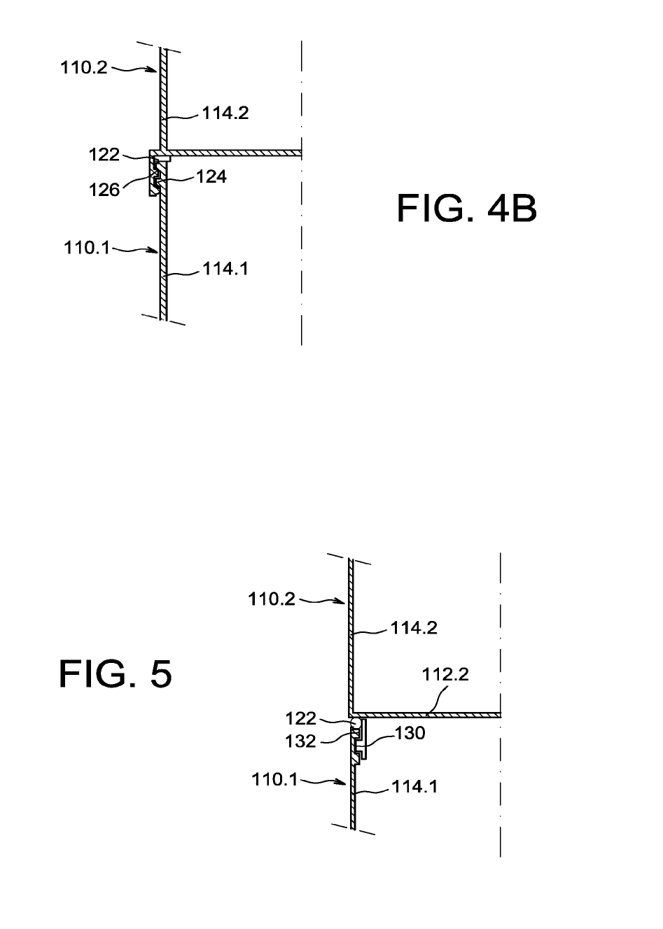

In FIG. 4A may be seen a practical example of a first embodiment of a lower cup cooperating with an upper cup. In this example, the cups are locked together by clipping means. Very advantageously, a sealing means 122, for example an O-ring, is interposed between the base 112.2 of the upper cup 110.2 and the free end 116.1 of the lower cup 110.1 in order to ensure good sealing. The joint may be independent and put in place during the assembly of the two cups or be integral with one or the other of the cups. The closing of the lower cup by the upper cup may be sufficient without using a sealing joint.

The clipping means, in the example represented, are the following: the free end 116.1 of the lower cup 110.1 comprises one or more elements 117.1 radially projecting towards its inner surface. The base of the upper cup 112.2 has on its face intended to be situated inside the volume of the lower cup 110.1 one or more elements 118.2 provided with a radial projection 120.2 towards the exterior. The radial projection(s) 120.2 and the projecting element 117.1 cooperate by clipping. The element 118.2 may be a ring and the element 117.1 may also be an annular projection. But it may be envisaged to form discrete elements 117.1 cooperating with the ring 118.2 or conversely to form an inwards radial projection 117.1 of annular shape and discrete elements 118.2 or instead formed of discrete elements 117.1 cooperating by clipping with the discrete elements 118.2. It will be understood that the elements 117.1 and 118.2 could be inverted between the lower cup 110.1 and the upper cup 110.2.

In FIG. 4B, may be seen another example of formation of a lower cup and an upper cup cooperating by screwing.

A threading 124 is formed on the outer face of the side wall of the lower cup 110.1 and the upper cup 110.2 comprises an annular element 126 extending longitudinally from a face of the base 112.2 opposite to that bearing the side wall 114.2. The annular element 126 is provided on its inner face with a tapping cooperating with the threading 124 of the lower cup. A joint 122 is advantageously arranged between the base of the upper cup and the free end of the lower cup, for example a flat joint.

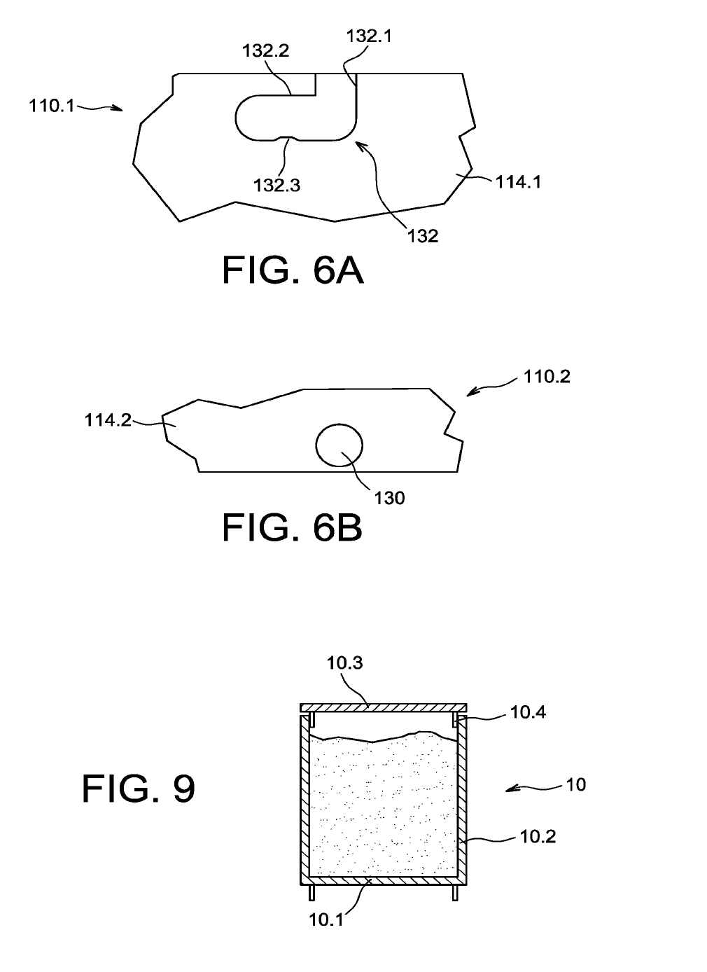

In FIGS. 5 and 6A and 6B may be seen another particularly advantageous example of sealed closing of the lower cup by cooperation between the lower cup and the upper cup. In this example, bayonet type means are implemented.

The upper cup 110.2 comprises a slug 130, advantageously several slugs 130, extending radially, each slug 130 cooperating with a slide or a notch 132 formed on the lower cup 110.1. For example, the notch(es) 132 comprise a first portion 132.1 extending parallel to the longitudinal axis and emerging in the free end of the side wall 114.1 and a second portion 132.2 extending in a plane perpendicular to the longitudinal axis. The slugs 130 penetrate firstly into the first portion 132.1 of the notches 132 by axial coming closer of the two cups. A relative movement around the longitudinal axis of the two cups ensures the locking of the two cups. In FIG. 6A may be seen the slug in detail and in FIG. 6B may be seen the notch 132.

Advantageously, the second portion 132.2 of the notch comprises an intermediate boss 132.3 forming a hard point to get over by the slugs during the relative rotation of the cups, improving the locking between the cups.

Advantageously a sealing means 122 is provided between the lower cup 110.1 and the upper cup 110.2, for example between the base of the upper cup 110.2 and the free end of the lower cup 110.1. In FIG. 11 may be seen a cup provided with notches 132 at the level of the free end of the side wall and slugs 130 at the level of the base. A joint 122 is mounted on the base.

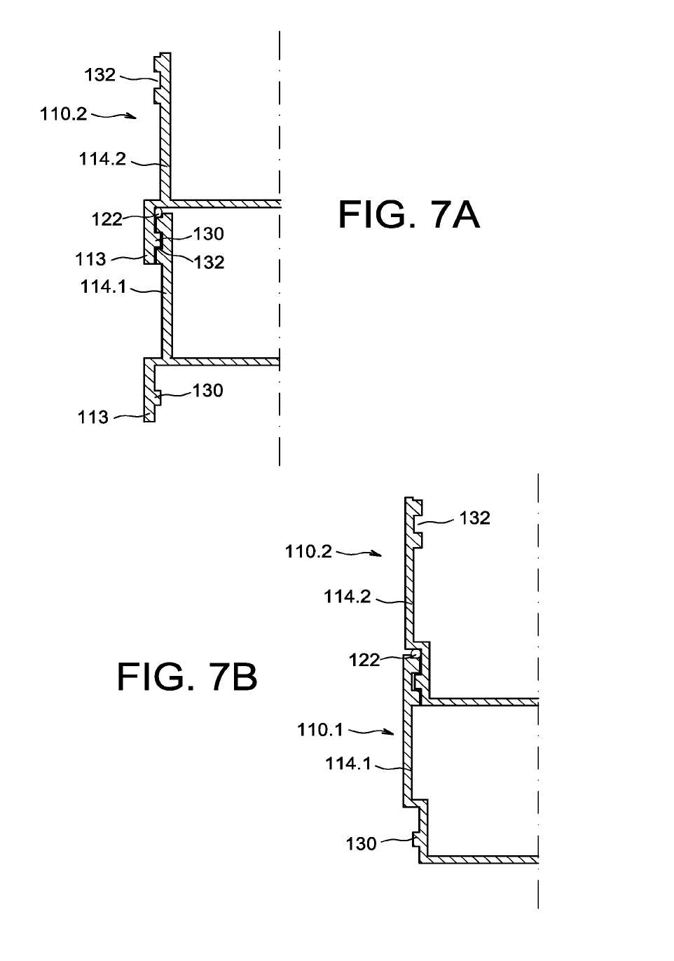

In FIGS. 7A and 7B may be seen variants of the bayonet locking means.

In FIG. 7A, the upper cup 110.2 comprises an annular element 113 extending longitudinally from a face of the base opposite to that bearing the side wall 114.2. Slugs 130 are borne by the inner face of the annular element 113. The notches 132 are formed in the outer face of the lower cup. In this example, it is the lower cup which penetrates into the annular element 113 of the upper cup 110.2. In FIG. 7B, it is the upper cup that penetrates into the lower cup. In this case the slugs 130 are formed directly projecting from the side wall of the upper cup 110.2, and the notches 132 are formed in or on the inner face of the side wall of the lower cup 110.1.

The variant of FIG. 7B has the advantage of being more efficient in thermal terms than the variant of FIG. 7A because the distance between the hydride and the wall is minimised.

In the embodiment of FIG. 7B, the portion of the lower cup comprising the slugs has a reduced diameter compared to the remainder of the cup. Alternatively, it could be envisaged that the upper cup has a constant diameter and that the lower cup comprises a portion bearing the notches with an increased diameter compared to the portion situated on the side of the base.

It will be understood that any other means ensuring a sealed closing and a locking between two cups fall within the scope of the present invention. These closing means have the advantage of being able to open the cup if it is wished to replace the storage material. Definitive closing and locking means between cups do not go beyond the scope of the present invention.

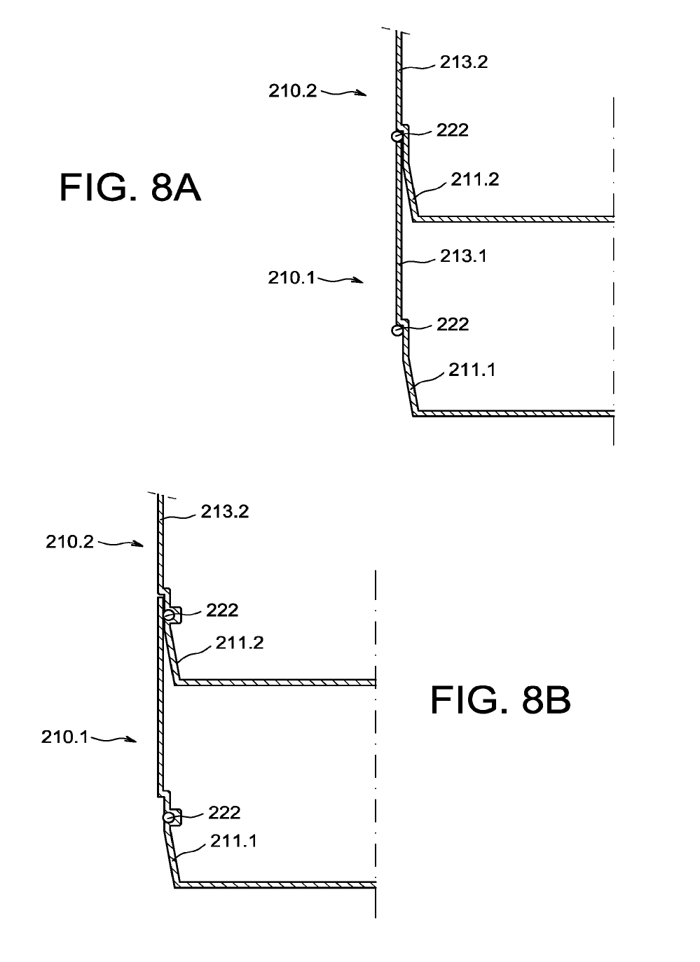

In another example of embodiment represented in FIGS. 8A and 8B, the lower cup is closed in a sealed manner by a simple nesting of the upper cup in the lower cup.

Advantageously, means of alignment of the cups with each other may be provided, for example they may be formed by a ferrule system or centring slug situated under the cup enabling a substantial alignment of the axes of the cups.

In this example, the base and the side wall of the cups may be produced by forming. The side wall 214.1 of the cup 210.1 has a lower portion 211.1 of reduced diameter and an upper portion 213.1 of larger diameter. The lower portion 211.1 has an outer diameter equal to or slightly greater than the inner diameter of the upper portion 213.1 of the side wall. The upper cup 210.2 may be mounted tightened or slightly with force in the lower cup 210.1. The base of the cup may have a conical part, as is represented, to facilitate nesting. The cover closing the cup at the top of the stack has a diameter equal to the inner diameter of the upper portion of the cup or slightly greater than it.

The nesting thus achieved ensures a sealed closing but does not ensure in general a locking of the cups with each other. A joint 222 may be provided, in the example represented it is arranged on the lower portion 211.1 of the cup at the junction between the lower portion 211.1 and the upper portion 213.1. In FIG. 8B, the joint 222 is received in an annular gorge formed directly in the lower portion 211.1, 211.2. Preferably, the stack of nested cups arranged in the chamber is maintained in place thanks to one or more springs R working in compression in the axis of the stack and placed preferentially above the stack of cups, as is represented in FIGS. 1 and 2. In this particular case, the spring is supported on one side in the upper rounded base of the chamber and on the other side on the cover of the upper cup. The spring maintains contact between consecutive cups and between the upper cup and its cover to ensure the impermeableness of the cups to the powder.

In FIG. 9, may be seen an example of formation of a cup of a tank according to the invention. The cup 10 comprises a base 10.1, a side wall 10.2 and a cover 10.3. The base 10.1 and the side wall 10.2 form a recipient provided with an upper opening that seals off the cover 10.3 in a manner impermeable to the storage material in powder form. Advantageously centring means 10.4 are provided for the assembly of the cover 10.3 on the side wall 10.2. Sealing means may advantageously be implemented between the cover and the side wall.

In this example, the cup 10 realises the impermeableness to the powder independently of the other cups. Once filled and closed, the cup 10 may be handled.

The examples of sealed closing means described above in the case of the cooperation of the cups in FIGS. 3 to 7B are applicable to the sealed closing of an individual cup, these means being formed between the cover and the side wall of the cup.

The joints which are advantageously implemented to increase sealing are made of elastomer, polymer, carbon or metals. The use of a joint may be avoided if the cooperation between the lower cup and the upper cup or between the side wall of the cup and the cover offers sufficient sealing. The joint(s) implemented may be impermeable or not to hydrogen.

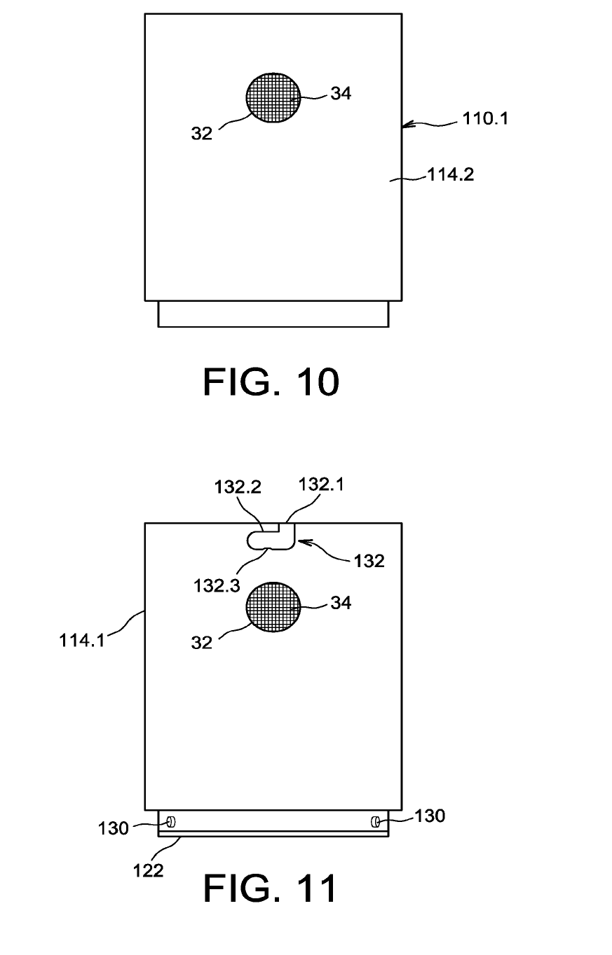

The cups according to the invention are moreover partially or totally permeable to hydrogen. As has been explained above, the supply of hydrogen and the collection of hydrogen are achieved by means of the channel P delimited between the side walls of the cups and the chamber and through a part at least of the side walls. In an example of embodiment represented in FIGS. 10 and 11, the cup 110.2 comprises at least one opening 32 formed in the side wall 114.2 of the cup and sealed off by an element 34 ensuring impermeableness to the powdered storage material. As has been detailed above, the element 34 impermeable to the powder is such that it forms a barrier for more than 90% by weight of the storage material arranged in the cup.

The element 34 impermeable to the powder is for example formed by a grating of which the size of the meshes is below 100 μm. Alternatively it may be formed by a porous material, such as a sintered material, for example made of sintered polymer or sintered metal, or by a fabric having a mesh size below 100 μm. The element 34 impermeable to the powder covers the whole opening 32.

The choice of the sealing element is made as a function of the distribution of the particles composing the storage material depending on their size such that it is capable of preventing the passage of more than 90% by weight of the material stored in the cup. Thus the size of the meshes is such that the weight of particles that can pass through the meshes of the sealing element represents less than 10% of the total weight of the material stored in the cup. This distribution is a piece of data known to those skilled in the art as a function of the storage material. Uniquely as an example, in the case of a powder centred on 200 μm by weight distribution (i.e. 50% of the mass of the powder is composed of particles of size below 200 μm), by choosing a filter of which the mesh size is 76 μm, effectively the passage of less than 10% by weight of the particles of powder is allowed.

Preferably, when the element 34 impermeable to the powder is transferred onto the cup after the formation thereof, it is fixed on the inner face of the side wall.

Preferably, the cup comprises several openings 32 spread out on its periphery to increase the surface for the passage of hydrogen and ensure a homogeneous supply and collection of hydrogen over the whole periphery of the cup. The shape of the openings may be any shape.

Also preferably, the opening(s) 32 are formed in the upper part of the side wall, thus the element 34 impermeable to the powder is protected from the finest particles which accumulate naturally at the base of the cup, the clogging of the sealing element is thus avoided.

In the example of formation of openings in the side surface of the cups for the passage of hydrogen, the section of passage may not be sufficient to avoid the appearance of an important pressure difference between the inside and the outside of the cups in the case of sudden variations in pressure and high flow rates. It may then be provided to limit voluntarily the flow rate of hydrogen in the chamber, for example by means of a calibrated orifice placed at the inlet of the pressure chamber.

Alternatively, in order to offset this risk of appearance of pressure difference, the section of passage may be increased for example by increasing the number of openings 32.

In a particularly advantageous variant, the cups are made of plastic material capable of withstanding the operating temperatures, of the order of 80° C., for example made of polypropylene, polyurethane, polyethylene terephthalate, polyamide, etc. The plastic material is advantageously moulded. It is then preferably provided prior to the injection of the plastic material in the mould to arrange in the mould the element(s) impermeable to the powder in the emplacement(s) provided for the openings so as to over-mould the sealing element(s). Thus the sealing elements are directly integrated in the cup. The plastic material is chosen so that, at the operating temperatures of the tank, it does not release any compound capable of polluting the storage material.

The cup may be made directly from material permeable to hydrogen, such as a porous sintered material, plastic or metallic for example. The formation of a cup made of porous material has the advantage of offering a sufficiently large section of passage of hydrogen to ensure efficient balancing of the hydrogen pressure between the inside and the outside of the cups.

Cups made of material permeable to hydrogen and comprising one or more openings 32 closed by an element 34 do not go beyond the scope of the present invention.

Plastic materials are less good thermal conductors than metal. The implementation of plastic cups in slow charge and discharge applications does not perturb the operation of the tank, since it is not sought to have rapid thermal exchanges.

The inner structure S, more particularly the cups, are mounted with play in the chamber, a passage P for the circulation of hydrogen is thus arranged between at least part of the periphery of the cups and the inner face of the chamber. This play represents from 0.1% to 20% of the inner diameter of the envelope of the chamber 4, preferably 1% of the inner diameter of the envelope of the chamber 4. Advantageously, if the speed is sufficient a turbulent flow may appear which is going to make it possible to increase thermal transfers with the chamber.

The tapping provided in the upper base makes it possible to supply this passage with hydrogen which is going to circulate up to the storage material through the openings formed in the cup or to extract hydrogen released by the storage material and escaping via the openings to the channel. The operation of the tank is as follows:

During a charge phase, hydrogen is injected into the chamber via the tapping, said hydrogen circulates in the passage P between the inner face of the chamber and the cups and penetrates into the cups through the openings 32 equipped with filtering elements 34 provided for this purpose and/or through the permeable material of the cups. The storage material is charged with hydrogen according to the reaction described above and gives off heat, this heat is evacuated thanks to exchanges with the outer face of the chamber either with a gas, or with a liquid circulating in a jacket. If the fluid is air and if the exchange takes place by natural convection, the jacket is not necessary. During this charge, the storage material swells and undergoes a decrepitation, that is to say a fractionation of the grains constituting the powder. This phenomenon is more important when it involves first charges. The storage material is thus transformed progressively into a finer and finer powder during successive charge-discharge cycles. The powder mainly remains confined in each impermeable cup and no accumulation of hydride powder that can perturb the operation of the tank appears outside said tank.

In discharge phase, the storage material is heated to bring about the desorption of hydrogen and its release. The desorbed hydrogen then escapes from the cups via the openings 32 equipped with filtering elements 34 or through the permeable cups. It is then collected in the passage P and evacuated via the tapping 7. The input of heat to the storage material takes place for example by making circulate in the jacket surrounding the chamber a hot heat transfer fluid. Thermal exchanges take place through the chamber, through the play between the chamber and the cups as well as through the wall of the cups.

The manufacturing of a tank will now be described.

The chamber may be formed beforehand by welding a lower base on a ferrule. In the case of an inner structure formed of independent cups (FIG. 9), recipients are made formed of the base and the side wall, at least the side wall comprising at least one area permeable to hydrogen.

Thanks to the invention, the manufacturing of the chamber and the cups does not require great precision because the mounting is made with play.

Several cups are filled with storage material and closed by a cover as has been described above. The quantity of material arranged in the cup is a function of the characteristics of the storage material. The storage material may be in the form of powder, blocks or granules having for example a diameter above 0.5 mm or in the form of pellets formed with compressed powder with or without additives.

The cups are then arranged in the chamber one on the other, until the chamber is filled. The inner diameter of the ferrule enables a mounting with play of the cups in the ferrule. It is not required to maintain the cups together, their relative positioning in the chamber may be free. A passage exists between the cups and the chamber whatever their positioning. A spring may potentially be put in place in compression at the top of the stack to ensure a maintaining of the stack.

After the upper cup has been put in place, the upper base of the chamber is fixed in a sealed manner on the ferrule, for example by welding.

In the case of cups cooperating with each other, the inner structure formed of a column of cups is formed outside of the chamber. To do so, a cup such as described in relation with FIGS. 7A and 7B is filled with a defined weight of material, a joint may be put in place on the free end of the cup, the cup is then closed by putting in place the upper cup. The upper cup is then filled and closed by another cup. These steps of filling and closing are repeated until the required height is reached. The final cup is closed by a cover, the latter is for example formed uniquely of a cut out base of cup, thus avoiding the formation of a specific part. The column thereby produced forms a monolithic assembly which may be handled, the powder being confined in a sealed manner in the cups. Once the column of cups formed, the assembly is placed in the pressure chamber. Advantageously, the column is placed horizontally in order to be slid into the pressure chamber, itself also horizontal. The upper rounded base is then fixed in a sealed manner on the ferrule for example by welding.

The invention moreover has the advantage of avoiding pollution of the welding area of the ferrule by the storage material, since this material is confined in the cups, it cannot be deposited on the welding area.

In the case of cooperation by nesting, the method is similar to that described above, apart from the step of locking successive cups together.

Then, after the putting in place of the upper cup, the cover is nested in the upper cup then the spring(s) are placed above the stack. The upper rounded base is closed in a sealed manner on the ferrule for example by welding, while maintaining a compressive force to close the pressure chamber by compressing the springs.

Advantageously, in all the embodiments, the operation of mounting of the cups in the pressure chamber is carried out in air, notably in the case where the hydride, for example non-decrepitated TiFeMn, is of a nature or in a form that is not affected by air from the point of view of storage performances.

The seasonal storage of hydrogen or storage over long periods is suited to this type of tank which does not have a very high thermal exchange capacity.

1-27. (canceled)

28. A tank for storing hydrogen by absorption in a hydrogen storage material, comprising:
a chamber;
an hydrogen supplier and collector device for supplying hydrogen into the chamber and collecting hydrogen in the chamber;
an inner structure for storing hydrogen storage material, the inner structure comprising at least two cups, each cup comprising a base, a side wall, and a closing element forming a volume impermeable to the hydrogen storage material, at least part of each cup being permeable to hydrogen, and the inner structure further comprising a passage provided at least between part of an outer face of the side wall of the cups and an inner face of the chamber, the hydrogen supplier and collector device being connected to the passage.

29. A tank according to claim 28, wherein the at least one part permeable to hydrogen is formed at least in the side wall of the cups.

30. A tank according to claim 29, wherein the side wall comprises at least one opening sealed off by an element impermeable to the hydrogen storage material and permeable to hydrogen.

31. A tank according to claim 30, wherein the element impermeable to the hydrogen storage material and permeable to hydrogen is a grating or a porous material or a fabric.

32. A tank according to claim 28, wherein at least the side wall is made entirely of a material impermeable to the storage material and permeable to hydrogen.

33. A tank according to claim 32, wherein at least the side wall is made of sintered material.

34. A tank according to claim 28, wherein the cups are self-supporting.

35. A tank according to claim 28, wherein the closing element of each cup is a cover, separate from other cups.

36. A tank according to claim 28, wherein the inner structure comprises plural stacked cups, the closing element of a lower cup being formed by a base of an upper cup.

37. A tank according to claim 36, wherein the cups cooperate by nesting.

38. A tank according to claim 36, further comprising a lock between the cups to make the cups integral with each other.

39. A tank according to claim 38, wherein the lock is a bayonet locker.

40. A tank according to claim 39, wherein the side wall of the lower cup comprises at least one slug or at least one notch and the base of the upper cup comprises at least one notch or at least one slug respectively, the at least one slug cooperating with the at least one notch by an axial coming closer movement and a rotational movement to lock the lower cup and the upper cup.

41. A tank according to claim 38, wherein the lock is of a screw type.

42. A tank according to claim 38, wherein the lock is of a clipping type.

43. A tank according to claim 28, further comprising a seal sealing against the hydrogen storage material, the seal being interposed between the side wall and the closing element of the cup.

44. A tank according to claim 28, wherein the cups are made of plastic material.

45. A tank according to claim 44, wherein the cups are made of molded polypropylene.

46. A tank according to claim 44, wherein the side wall comprises at least one opening sealed off by an element impermeable to the powdered storage material and permeable to hydrogen and in which the element impermeable to the hydrogen storage material and permeable to hydrogen is made integral with the side surface of the cups during the molding thereof.

47. A tank according to claim 28, further comprising a jacket surrounding at least in part the chamber, and means of circulating a heat transfer fluid in the jacket.

48. A method of manufacture of a storage material storage tank according to claim 28, comprising:
a) formation of the chamber;
b) formation of the cups;
c) filling of the cups with the storage material;
d) sealed closing of the cups;
e) putting in place in the chamber;
f) closing of the chamber.

49. A method of manufacture according to claim 48, wherein d) is carried out by covers separate from the other cups.

50. A method of manufacture according to claim 48, wherein d) is carried out by stacking of the cups, a lower cup being closed by an upper cup.

51. A method of manufacture according to claim 50, wherein d) comprises locking the cups together.

52. A method of manufacture according to claim 48, wherein b) takes place by molding of plastic material.

53. A method of manufacture according to claim 52, wherein during the molding, the element permeable to hydrogen is secured to a remainder of the cup.

54. A method of manufacture according to claim 48, wherein during b), the cups are formed by sintering to be impermeable to the powdered storage material and permeable to hydrogen.
